(19) United States
(12) Patent Application Publication
(10) Pub. No.: US 2010/0011297 A1
(43) Pub. Date: Jan. 14, 2010

(54) METHOD AND SYSTEM FOR GENERATING INDEX PICTURES FOR VIDEO STREAMS

(75) Inventors: Yu-Pao Tsai, Taipei (TW); Shyn-Kang Jeng, Taichung (TW); Gwo-Cheng Chao, Taichung (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/359,327

(22) Filed: Jan. 25, 2009

(30) Foreign Application Priority Data
Jul. 9, 2008 (TW) 97125847

(51) Int. Cl. G06F 3/048

(52) U.S. Cl. 715/721

(57) ABSTRACT

A method and system is proposed for generating index pictures for video streams, where the index pictures can be used in a video database for visual browsing by users to quickly find and retrieve video clips or files from the video database. The proposed method and system operates in such a manner as to first create a set of content items of particular interest or concern (particularly moving objects), and then combine each content item together with an associated activity record dataset in a predefined manner into a single image to serve as an index picture. In practice, each moving object and its associated activity record dataset can be displayed by means of 2D (two-dimensional) or 3D (three-dimensional) graphic icons or imagery.

### BACKGROUND OF THE INVENTION

1. Field of the Invention

This invention relates to digital video processing technology, and more particularly, to a method and system for generating index pictures for video streams where the index pictures can be used in a video database for visual browsing by users to quickly find and retrieve user-interested video clips or files from the video database.

2. Description of Related Art

With the advances in computer-based digital video technology, users of video cameras can now capture digitized video streams and download these video streams as binary files for storage in databases and display on computer monitor screens. In practical applications, video databases typically contain a great number of video files. For this sake, the user needs a quick retrieval method for finding the desired video file from the database. Presently, one method for quick retrieval of video files is to select some key frames of an input video file and convert it into a short video or small-size thumbnail pictures so that the short video or the thumbnail pictures can be used as a visual index for the user to quickly find and retrieve the desired video file. Typically, a key frame is decided by such a criterion that if the content of a certain frame is largely different from its preceding frame (typically representing a change from one scene to another), this frame can then be selected as a key frame. Conventionally, this technique is commonly referred to as video indexing or video summarization.

In practical applications, however, this video summarization method, which is based on scene change detection, is only suitable for the indexing of movie or TV programs, but unsuitable for home videos and security monitoring videos. In practice, however, the video summarization method based on scene change detection is only suitable for use on edited movies in which a scene change from one frame to the next is obvious and thus easily detectable. For home video or surveillance video applications, this method might be unsuitable since these kinds of video streams are typically captured from a fixed locality. In the application of video-based security monitoring systems, the captured video images are typically organized and stored in a database so that security personnel can later retrieve these video files for investigation purposes. In reality, however, security monitoring video files are typically recorded all day long, i.e., 24 hours a day; and when unauthorized intrusion occurs, only a short length of the security mentoring video recording, for example 5 to 10 minutes, needs to be viewed by the security personnel for investigation purpose. For this sake, it would be infeasible for the security personnel to create index pictures for the captured video files in advance by viewing the very lengthy video recording.

In view of the aforementioned problem, there exists a need in security monitoring video systems for a new technology that is capable automatically creating index pictures for each security monitoring video file, such that the security personnel can quickly find and retrieve from the video database a certain video file whose content is specifically related to unauthorized intrusion events.

### SUMMARY OF THE INVENTION

It is therefore an objective of this invention to provide a new method and system for generating index pictures for video streams where the index pictures can be used in a video database for visual browsing by users to quickly find and retrieve user-interested video clips or files from the video database.

Defined as a method, the invention comprises the following processes: (M1) performing a content extraction process on the video stream to thereby extract a set of content items of predefined interest from the video stream, where the content items of predefined interest include at least one moving object and associated motion status data; and (M2) performing a content synthesis process on the extracted content items to thereby create at least one resultant picture that shows all the content items of predefined interest in a predefined manner in which each moving object of predefined interest is tagged with an activity record dataset used to indicate information about the activity of each moving object.

In one preferred embodiment of the invention, an ROI (region of interest) can be user-predefined in the monitored site, such that when any moving object enters the RIO, its imagery and related attributes will be all recorded and processed as content items. In another preferred embodiment of the invention, the ROI region can be defined in such a manner that when a moving object moves from one particular direction to the other, for example from left to right, the moving object will be regarded as a content item of interest or concern and thus extracted (which means that if something moves from right to left, it will not be extracted as a content item of interest or concern).

Defined as a system for performing the foregoing method, the invention comprises: (A) a content extraction module for performing the content extraction process (M1); and (B) a content synthesis module for performing the content synthesis process (M2).

In operation, the method and system according to the invention operates in such a manner as to first create a set of content items of particular interest or concern (particularly moving objects), and then generate one or more resultant images (i.e., index pictures) each showing one or more content items of particular interest or concern. If multiple content items are extracted from multiple video segments, these multiple content items can be either each shown individually on one associated index picture, or alternatively shown collectively on the same single index picture.

### BRIEF DESCRIPTION OF DRAWINGS

The invention can be more fully understood by reading the following detailed description of the preferred embodiments, with reference made to the accompanying drawings, wherein:

FIGS. 1A-1B are schematic diagrams used to depict the I/O functional model of the invention;

FIG. 2 is a schematic diagrams showing the basic architecture of the invention;

FIGS. 3A-3C are schematic diagrams used to depict an application example of the invention in the case of one single moving object;

FIGS. 4A-4B are schematic diagrams used to depict an application example of the invention in the case of multiple moving objects;

FIG. 5 is a schematic diagram showing a preferred embodiment of the invention derived from the basic architecture shown in FIG. 2; and

FIG. 6 is a table showing an example of a set of motion marks utilized by the invention.

### DETAILED DESCRIPTION OF PREFERRED EMBODIMENTS

The method and system for generating index pictures for video streams according to the invention is disclosed in full details by way of preferred embodiments in the following with reference to the accompanying drawings.

### Function of the Invention

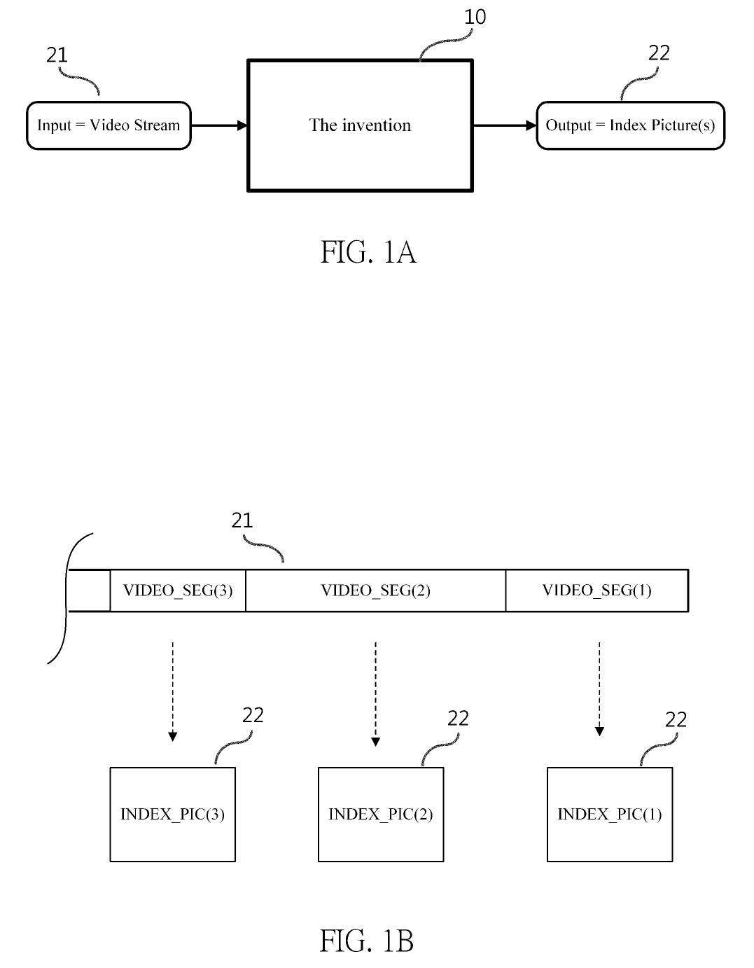

FIG. 1A shows the I/O (input/output) functional model of the system of the invention (which is here encapsulated in a box indicated by the reference numeral 10). As shown, the system of the invention 10 is used for processing an input video stream 21, such as a video stream captured by a security monitoring video camera (not shown), with the purpose of creating one or more index pictures 22 for the input video stream 21. When the input video stream 21 is stored as computer files or clips together with a large collection of other video files in a database, these index picture(s) 22 can be used as visual indexes that can help users to quickly find and retrieve files or clips of particular interest related to the input video stream 21 from the database.

In practice, as depicted in FIG. 1B, the input video stream 21 may include one or more video segments of particular interest or concern, such as N segments represented by VIDEO_SEG(1), VIDEO_SEG(2) . . . , VIDEO_SEG(N). These video segments can be either varied or fixed in length (such as a fixed length of 5 minutes), each recording one particular event of interest or concern that happened in the monitored site. In this case, the system of the invention 10 will correspondingly generate at least one index picture for each of these video segments, which are here represented by INDEX_PIC(1), INDEX_PIC(2), . . . , INDEX_PIC(N). In accordance with one important aspect of the invention, each moving object in each index picture is to be displayed together with an activity record dataset that is used for indicating related information about the presence and motion of each moving object in the associated video segment of the input video stream 21. In one preferred embodiment of the invention, multiple detected events or moving objects can be displayed in a side-by-side manner through one single index picture, so that the user can learn the contents of a video file simply by viewing one single index picture. In another preferred embodiment of the invention, 2D (two-dimensional) or 3D (three-dimensional) graphic icons can be used for graphic representation of each moving object as well as its related activity record dataset and associated motion attributes, such as directions of movement, motion status (moving or stopping at particular localities), time/date of presence, and so on.

### Basic Architecture of the Invention

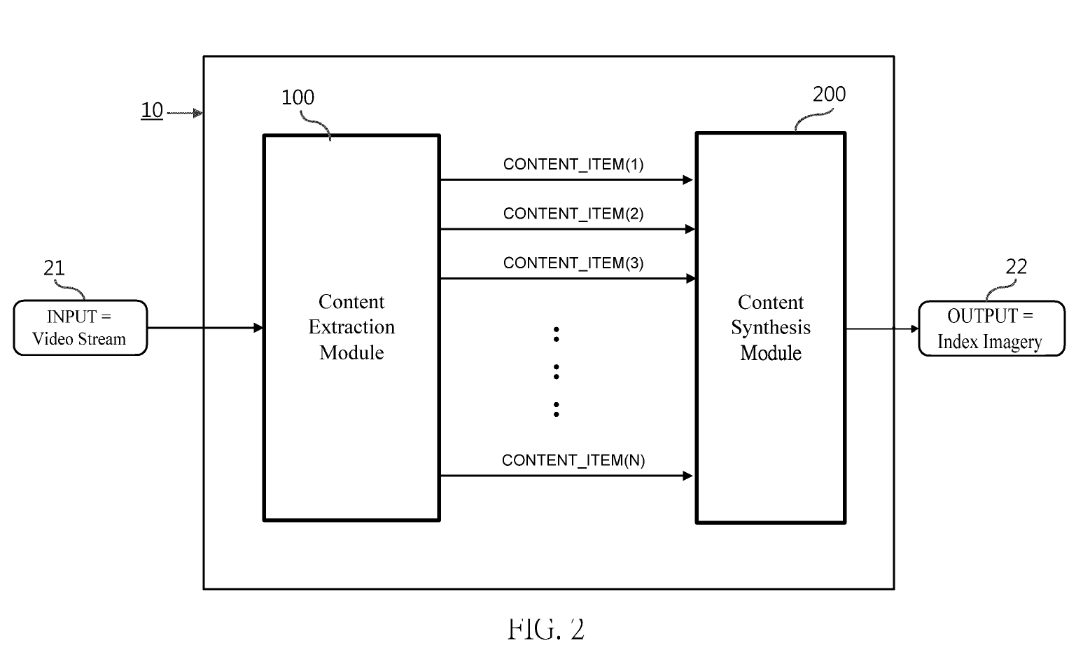

As shown in FIG. 2, in basic architecture, the system of the invention 10 comprises two modules: (A) a content extraction module 100; and (B) a content synthesis module 200. Firstly, the respective attributes and functions of these modules of the invention are described in details in the following.

### (A) Content Extraction Module 100

The content extraction module 100 is used to perform a content extraction process on the input video stream 21 to thereby extract a set of content items of predefined interest or concern from the input video stream 21, where the content items can be background objects or foreground moving objects and their related attributes, such as persons and their faces and motions, automobiles and their number plates and motions, to name a few. In one preferred embodiment of the invention, an ROI (region of interest) can be user-predefined in the monitored site, such that when any moving object enters the RIO, its imagery and related attributes will be all recorded and processed as content items. In another preferred embodiment of the invention, the ROI region can be defined in such a manner that when a moving object moves from one particular direction to the other, for example from left to right, the moving object will be regarded as a content item of interest or concern and thus extracted (which means that if something moves from right to left, it will not be extracted as a content item of interest or concern).

### (B) Content Synthesis Module 200

The content synthesis module 200 is used to perform a content synthesis process on the content items CONTENT_ITEM(1), CONTENT_ITEM(2) . . . , CONTENT_ITEM(N) extracted by the content extraction module 100 from the input video stream 21 to thereby create at least one static image that is used to serve as an index picture 22 to show each of the extracted content items in a predefined style. In the index picture 22, each extracted moving object is represented in such a manner as to be tagged with an activity record dataset that indicates a set of related activity data about the moving object, such as directions of movement, motion status (moving or stopping at particular localities), time/date of presence, and so on. In one preferred embodiment of the invention, each moving object and related activity record dataset can be represented by means of 2D (two-dimensional) or 3D (three-dimensional) icons or other graphic representations.

### An Application Example of the Invention

The following is a description of an application example and an exemplary embodiment of the invention. In this application example, it is assumed that the system of the invention 10 is applied for use to process a video stream that is captured by a security monitoring video camera (not shown) installed at a guarded site, such as the interior of an office building or a warehouse, with the purpose of creating one or more index pictures for each captured video stream whose content is specifically related to unauthorized intrusion events.

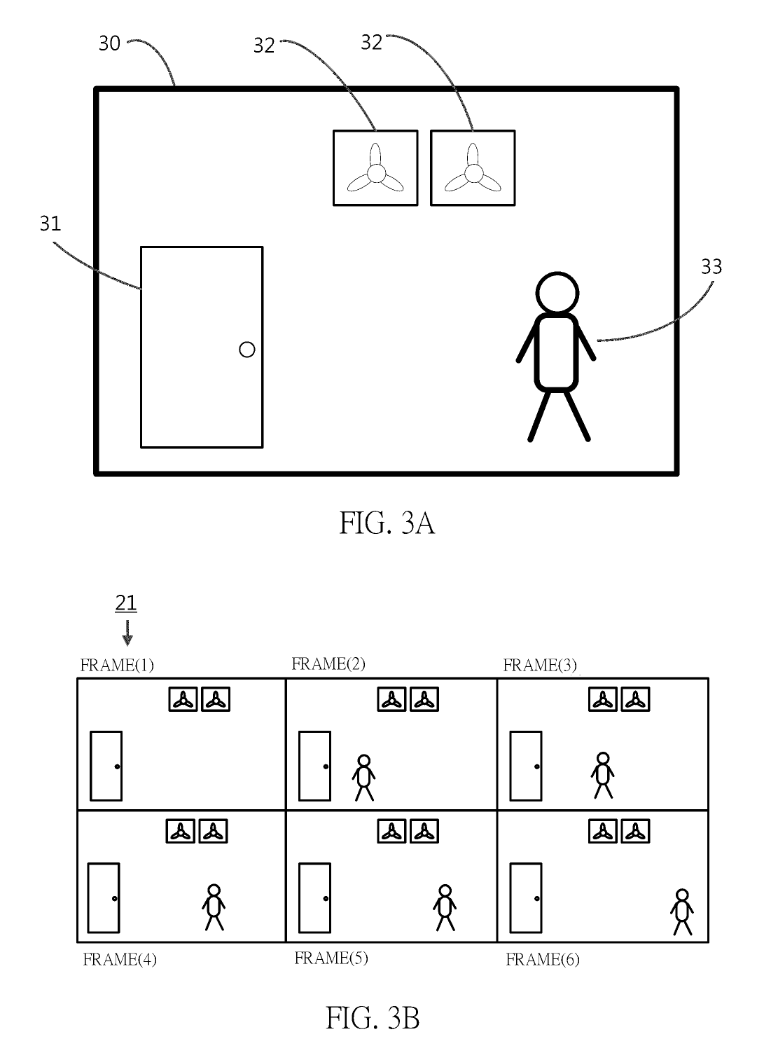

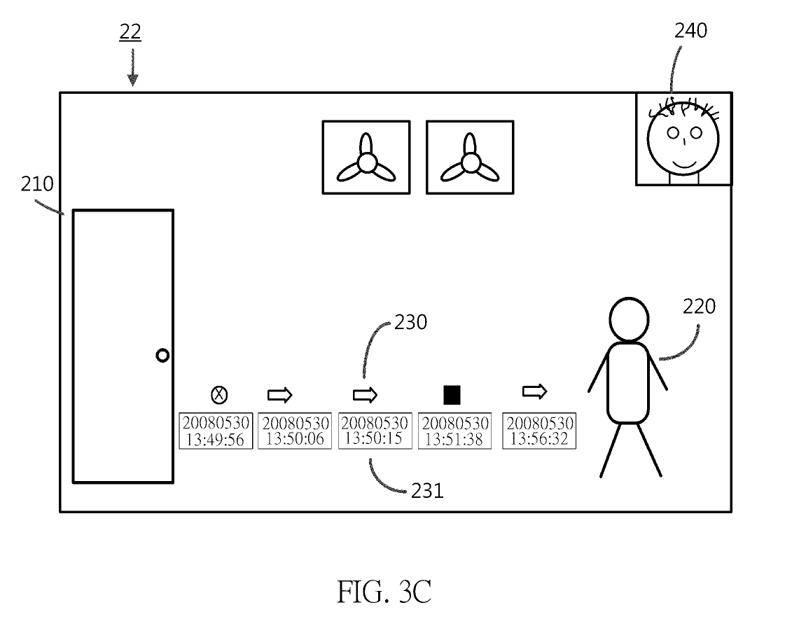

As shown in FIG. 3A, assume the input video stream 21 contains a segment of video images of the scene of a monitored site 30, such as the interior of an office building, with the presence of a static background 31 (such as walls, doors, windows, furniture, and so on), a motional background object 32 (such as electrical fans with rotating blades, clocks with a swinging pendulum or a rotating second hand, trees and flowers with swinging leaves and stems caused by wind, and so on). Further, it is assumed that a moving object 33 (such as an unauthorized intruder) appears in the scene of the monitored site 30, who enters into the scene of the monitored site 30 from the left side and leaves from the right side, as illustrated in FIG. 3B. The example of FIG. 3B shows a video segment of 6 frames FRAME(1)-FRAME(6) which capture the presence and motion of the moving object 33 in the scene of the monitored site 30; and FIG. 3C shows an example of a resultant index picture for the video segment of FIG. 3B.

As shown in FIG. 3C, in accordance with the invention, each resultant index picture is essentially composed of the following picture elements: (1) a background image 210, which represents all the background objects in the scene of the monitored site 30, including the static background 31 and every motional background object 32; (2) a representative object 220, and (3) a moving-object activity record dataset which is visually displayed by means of a set of activity record dataset which can include, for example, motion marks 230 and associated time tags 231; and (4) a feature image 240. The representative object 220 is a standout image of the moving object 33 selected from one of the multiple frames FRAME(1)-FRAME(6) of the video segment and is most representative of the moving object 33. In practice, the standout image of the moving object 33 can be created either by cutting the image of the representative object 220 out from the selected frame, or by converting all the surrounding image portion beside the moving object 33 into transparent state. The activity record dataset can be represented in icons, tags, tables, lists, or various other data representation schemes and are used for indicating a set of related activity information items about the moving object 33, such as its moving direction, temporal point (time/date) at specific locations during its movement, which side of the monitored site 30 where the moving object 33 enters into the scene, to name a few. The feature image 240 is used for revealing a distinguishing feature of the moving object 33 (in the case of the moving object 33 being a person, the feature image 240 is preferably the face of the person).

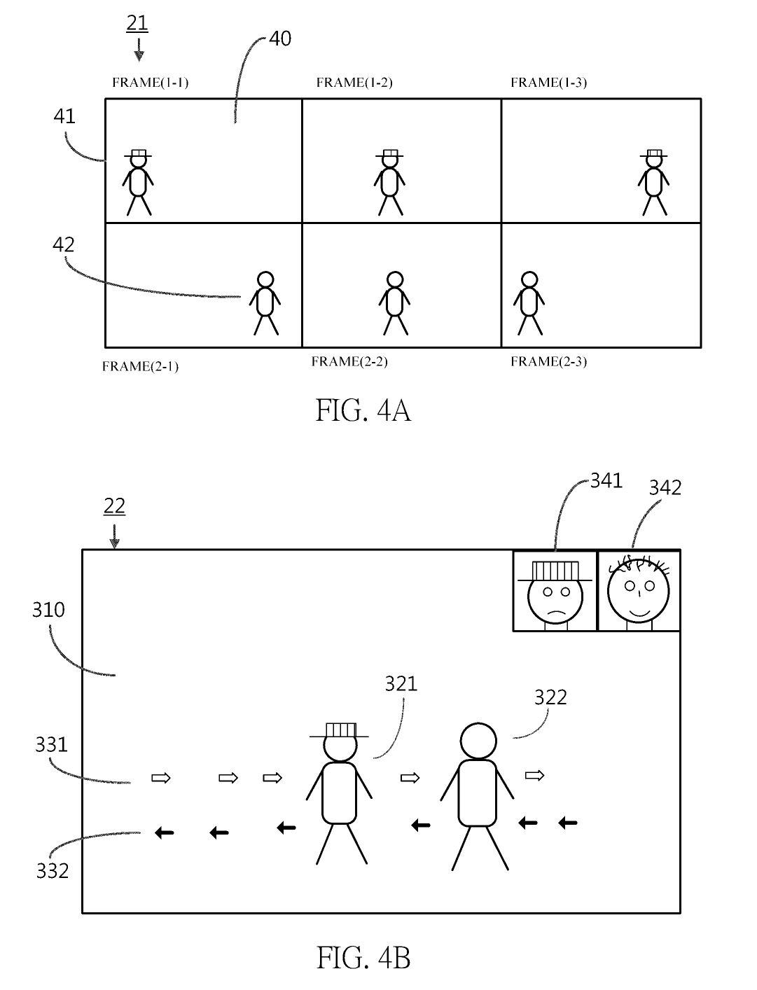

Moreover, as illustrated in FIGS. 4A-4B, the system of the invention 10 is also capable of providing a multiple moving object tracking capability for displaying the resultant index picture with two or more moving objects that have appeared in the scene of a monitored site 40 at different times. In the example of FIGS. 4A-4B, assume two moving objects 41, 42 (which are two persons) have appeared in the scene of the monitored site 40 at different times. In this case, the system of the invention 10 will create an index picture as illustrated in FIG. 4B that is composed of the following picture elements: (1) a background image 310, which represents all the background objects in the scene of the monitored site 40; (2) a first representative object image 321 for the first moving object 41 and a second representative object image 322 for the second moving object 42; (3) a first set of motion marks 331 for the first moving object 41 and a second set of motion marks 332 for the second moving object 42 (for simplification of the drawing, the associated time tags are not shown); and (4) a feature image 341 for the first moving object 41 and a feature image 342 for the second moving object 42. In one preferred embodiment of the invention, if multiple moving objects are involved, each moving object together with its associated activity record dataset representation is represented in a unique color, so as to allow the user to visually distinguish different moving objects easily.

It is to be noted that the foregoing example of FIGS. 4A-4B is directed to the tracking of two moving objects; but the number of moving objects that the invention can track is unlimited, and the invention is capable of tracking three or more moving objects and displaying these moving objects in the index picture.

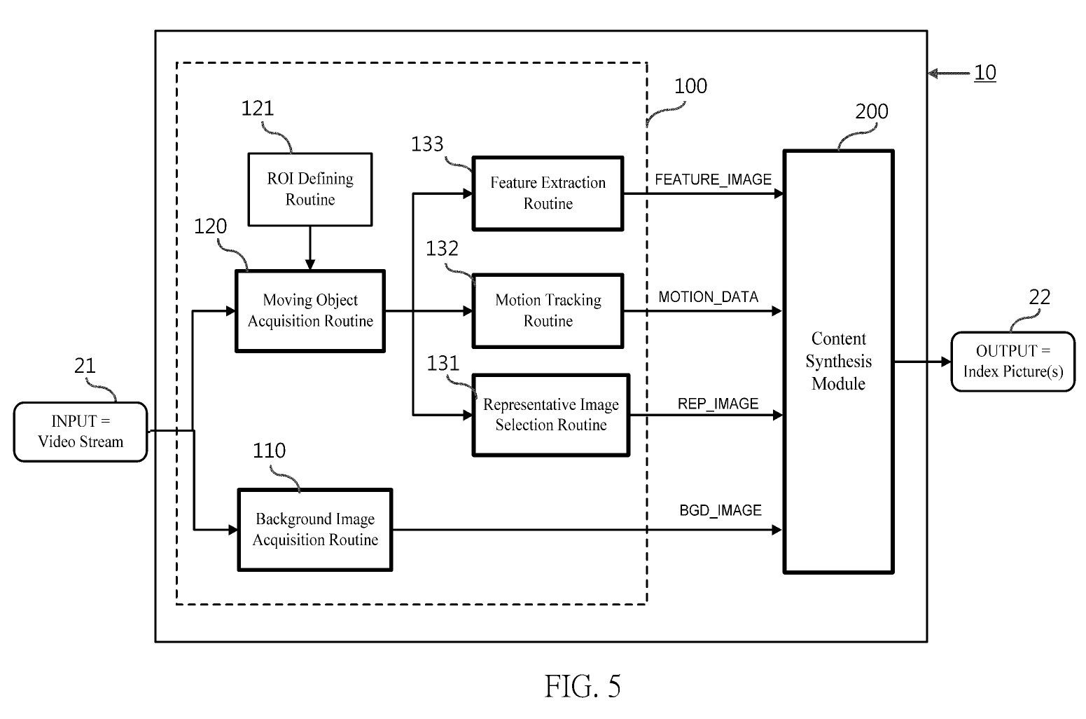

As shown in FIG. 5, to realize the system of the invention 10 for handling the above-mentioned conditions, the content extraction module 100 is implemented in such a manner as to include: (A1) a background image acquisition routine 110; (A2) a moving object acquisition routine 120 and a user-interested-event defining routine 121; (A3) a representative object selection routine 131; (A4) a motion tracking routine 132; and (A5) a feature extraction routine 133. However, it is to be noted that the content extraction module 100 can be implemented in various other manners.

The background image acquisition routine 110 is an optional component which is capable of processing the input video stream 21 to thereby obtain a static background image (expressed as BGD_IMAGE) representative of the background of the scene of the monitored site 30. The background image BGD_IMAGE should contain every static background object (such as walls, doors, windows, furniture, and so on) and every motional background object (such as electrical fans with rotating blades, clocks with swinging pendulums, trees and flowers with swinging leaves and stems caused by wind, and so on). In the case of the scene of the monitored site 30 shown in FIG. 3A, the background image BGD_IMAGE should contain the static background 31 (wall and door) and the motional background object 32 (electrical fans). In practice, the background image acquisition routine 110 can be activated for producing the background image BGD_IMAGE initially after being installed when no intruding objects appear in the scene of the monitored site 30; i.e., by first capturing a segment of video images of the scene of the monitored site 30 and then comparing these video images to find those pixels whose color values remain unchanged all the time (whereby the image of the static background 31 is defined), and to find those pixels whose color values are changing in a cyclic manner (whereby the image of the motional background object 32 is defined). In some applications, the video camera may operate in a swaying manner so that a wider region of the monitored locality can be scanned. In this case, the background of the monitored locality will be recorded in a sequence of multiple consecutive frames. If it is desired to extract the background as a content item, the multiple background images can be extracted from these frames and then stitched together into one single image. The stitched image can then be used as a content item for integration to the index picture. Since the above-mentioned digital video processing methods used to define the static background 31 and the motional background object 32 are conventional techniques, detailed description thereof will not be given in this specification.

The moving object acquisition routine 120 is capable of processing the input video stream 21 for acquisition of the images of each moving object that appears in the scene of the monitored site 30 other than the static background 31 and the motional background object 32 in the background image BGD_IMAGE. Moreover, the moving object acquisition module 120 can be optionally integrated with the user-interested-event defining routine 121 which allows the user to predefine an ROI (region of interest) in the scene of the monitored site 30, such that when any moving object reaches or passes through the locality defined by the ROI, the video imagery of the moving object will be extracted as a content item of concern for display in the resultant index picture(s) 22. In one preferred embodiment of the invention, the user-interested-event can be based on a user-predefined ROI (region of interest) in the monitored site, such that when any moving object enters the RIO, its imagery and related attributes will be all recorded and processed as content items. In another preferred embodiment of the invention, the user-interested-event can be defined as an event of a moving object that moves from one particular direction to the other, for example from left to right. In this case, the moving object will be regarded as a content item of interest or concern and thus extracted (which means that if something moves from right to left, it will not be extracted as a content item of interest or concern).

In the case of the example shown in FIGS. 3A-3C, a moving object 33 is recognized, which appears and moves in the scene of the monitored site 30 and whose motions are captured and recorded in the video segment of the frames FRAME(2) through FRAME(6) as shown in FIG. 3B.

In the case of the example shown in FIGS. 4A-4B, two moving objects 41, 42 are recognized, which appear and move in the scene of the monitored site 40 at different times, where the motions of the first moving object 41 are captured and recorded in a first video segment of the frames FRAME(1-1) through FRAME(1-3), while the motions of the second moving object 42 are captured and recorded in a second video segment of the frames FRAME(2-1) through FRAME(2-3).

The representative object selection routine 131 is capable of processing the video segment that captures each moving object's presence and motions in the scene of the monitored site to thereby obtain the image of a representative object image (expressed as REP_OBJECT) for each moving object. In the example of FIGS. 3A-3C, a representative object image is selected for the moving object 33 from the frames FRAME(2) through FRAME(6); whereas in the example of FIGS. 4A-4B, one representative object image is selected for the first moving object 41 from the frames FRAME(1-1) through FRAME(1-3) and another representative object image is selected for the second moving object 42 from the frames FRAME(2-1) through FRAME(2-3).

Fundamentally, in the case of the moving object 33 being a person, the representative object image REP_OBJECT is preferably one that shows the person's full body and face, or the maximum possible portion of the person's full body and face. The content synthesis module 200 will then paste the extracted image of the person to the index picture. On the other hand, in the case of the moving object being an automobile, the representative object image REP_OBJECT is preferably one that shows the automobile's full body and number plate.

In practice, for example, the representative object selection routine 131 is implemented by using a conventional image recognition method called global energy minimization. This global energy minimization image recognition method can be either based on a belief propagation algorithm or a graph cuts algorithm. For details about this technology, please referred to the technical paper “What energy functions can be minimized via graph cuts” authored by V. Kolmogorov et al and published on Proceedings of the 7th European Conference on Computer Vision.

The motion tracking routine 132 is capable of tracking the motions of each moving object detected by the moving object acquisition routine 120 to thereby generate a set of motion status data (expressed as MOTION_DATA) for each moving object. The motion status data MOTION_DATA includes, for example, the information about the locations of each moving object where the tracking is started and ended, the locations where each moving object enters and leaves the scene of the monitored site, the motional directions of each moving object in the scene of the monitored site (i.e., moving left, moving right, moving forward, moving backward). Moreover, the motion status data MOTION_DATA can additionally includes a set of date/time data which record the date and time when each moving object appears at a particular location in the scene of the monitored site.

The feature extraction routine 133 is capable of processing the images of each moving object appearing in the input video stream 21 to thereby obtain a feature image (expressed as FEATURE_IMAGE) for each moving object. For example, in the case of the moving object being a person, the feature extraction routine 133 can perform a face recognition process (which is a conventional technology) for extracting the person's face image as the feature image FEATURE_IMAGE. On the other hand, in the case of the moving object being an automobile, the feature extraction routine 133 can perform a number plate recognition process (which is also a conventional technology) for extracting the image of the automobile's number plate as the feature image FEATURE_IMAGE.

In practice, for example, the face recognition process performed by the feature extraction routine 133 is preferably implemented by using a principal component analysis (PCA) method which is disclosed in the technical paper entitled “Face Recognition Using Eigenfaces” authored by M. A. Turk et al and published on Proceedings of the IEEE Conference on Computer Vision and Pattern Recognition.

The content synthesis routine 200 is capable of creating one or more index picture(s) 22 for the input video stream 21 by performing the following synthesis processes: (P1) a representative object image overlaying process; (P2) an activity record dataset overlaying process, which is used to add the contents of the activity record dataset (i.e., motion status, events, time stamps, etc.) in text or graphic representations to the background image; (P3) a feature image overlaying process; and (P4) a hyperlink embedding process. Details of these processes are described in the following.

The representative object image overlaying process P1 is used to overlay the representative object image REP_OBJECT produced by the representative object image selection routine 131 over the background image BGD_IMAGE. In practice, for example, this process can further include a contour outlining procedure which outlines the contour of each moving object by using a unique color so that multiple moving objects can be visually distinguished from each other more easily by the user. This procedure also includes a background removal step for removing unwanted background objects by converting the unwanted background objects into transparent state. For example, in the case of three moving objects being tracked, three different colors, such as red, blue, and green, can be used to outline the contour of each of these 3 moving objects so that these 3 moving objects can be easily distinguished by human vision.

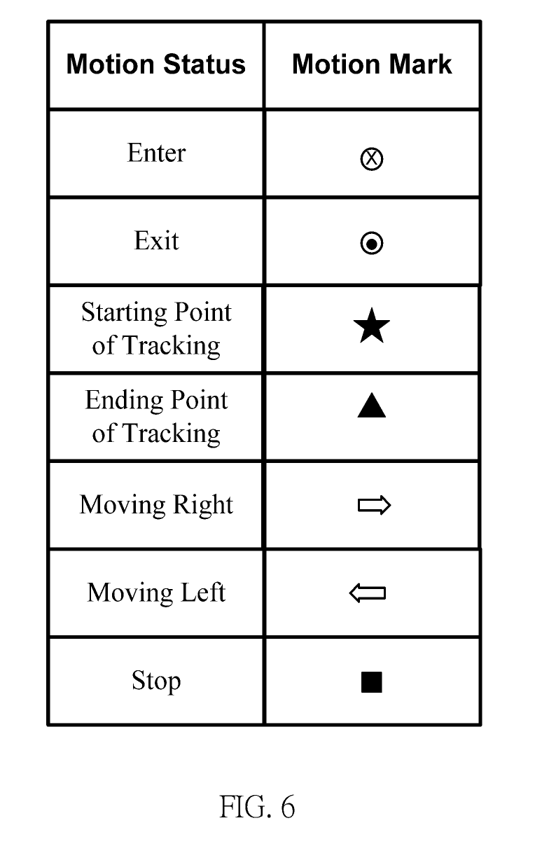

The activity record dataset overlaying process P2 first converts the motion status data MOTION_DATA produced by the motion tracking routine 132 into a set of motion marks (which are realized as a series of graphic icons for representing the multiple stages of movements of each moving object recorded by multiple frames) and then overlays these motion marks over the background image BGD_IMAGE at the specific locations in the scene of the monitored site. In practice, for example, the motion marks can be implemented by using the graphic icons shown in FIG. 6, which shows that the icon of a circled X is used to indicate the location where the moving object enters the scene of the monitored site; the icon of a circled dot is used to indicate the location where the moving object leaves the scene of the monitored site; the icon of a star is used to indicate the location where the tracking is started; the icon of a triangle is used to indicate the location where the tracking is ended; the icon of a left arrow is used to indicate that the moving object's direction of motion is to the left; the icon of a right arrow is used to indicate that the moving object's direction of motion is to the right; and the icon of a square box is used to indicate a temporal stop of the moving object during the course of motion. It is to be noted that the graphic icons shown in FIG. 6 are an arbitrary design choice, which can have many various other different forms and styles of embodiments. Moreover, as illustrated in FIG. 3C, each of the motion marks 230 can be further associated with a time tag 231 that shows the date and time of the presence of the moving object 33 at the location indicated by each motion mark 230. In practice, the graphic representations for the data items of the activity record dataset (i.e., motion marks, time tag, etc.) of each moving object 33 can be displayed in 2D or 3D graphic icons.

The feature image overlaying process P3 is performed to overlay the feature image FEATURE_IMAGE produced by the feature extraction routine 133 over the background image BGD_IMAGE. The overlay location is an arbitrary design choice which can be the upper-right corner, the bottom-right corner, the upper-left corner, the bottom-left corner, or anywhere on the background image BGD_IMAGE. As illustrated in FIG. 4B, if there are multiple moving objects, then the respective feature images (341, 342) can be either overlaid on the background image BGD_IMAGE of the same index picture (as in the example shown), or separately overlaid on two index pictures.

The hyperlink embedding process P4 is performed to embed a set of hyperlinks to specific portions of the resultant index picture, such as the icons of directional arrows, time tags, body parts of the moving object (such as a person's face, hand, or body, or an automobile's body or number plate), so that the user can click these image portions for linking to related information, such as a directory of video files or clips associated with the moving object. This hyperlink function allows the user to display and view the contents of the associated video files for inspecting the identity and actions of the moving object.

### Operation of the Invention

The following is a detailed description of a practical application example of the system of the invention 10 during actual operation with reference to the example shown in FIGS. 3A-3C.

In the first step, the background image acquisition routine 110 is activated to process the input video stream 21 to thereby obtain a static background image BGD_IMAGE representative of the background scene of the monitored site 30, including the static background 31 and every motional background object 32. Subsequently, the moving object acquisition routine 120 is activated to process the input video stream 21 to thereby detect each moving object 33 that appears in the scene of the monitored site 30. In the example of FIGS. 3A-3C, the moving object 33 appears in the video segment of the frames FRAME(2) through FRAME(6) as shown in FIG. 3B.

Next, the representative object image selection routine 131 is activated to select one of the images of the moving object 33 recorded in the video segment FRAME(2) through FRAME(6) that is most representative of the moving object 33, such as the one that shows the full body and face of the moving object 33, for use as a representative object image REF_IMAGE. In this embodiment, for example, the image of the moving object 33 recorded in FRAME(6) is selected as the representative object image REP_OBJECT.

Meanwhile, the motion tracking routine 132 is activated to track the motions of the moving object 33 to thereby generate a set of motion status data MOTION_DATA that indicates, for example, the moving direction, temporal point (time/date) of each step of the movement captured by one frame, and so on. The motion status data MOTION_DATA includes, for example, the locations of the moving object 33 where the tracking is started and ended, the locations where the moving object 33 enters and leaves the scene of the monitored site 30, and the motional directions of the moving object 33 (i.e., moving left, moving right, moving forward, moving backward). Moreover, the motion status data MOTION_DATA can additionally includes a set of date/time data which record the date and time when each moving object appears at a particular location in the scene of the monitored site.

Furthermore, the feature extraction routine 133 is also activated to process the images of each moving object 33 appearing in the input video stream 21 to thereby obtain a feature image FEATURE_IMAGE for the moving object 33. In the case of the moving object 33 being a person, the feature image FEATURE_IMAGE is preferably the full face of the person.

Finally, the content synthesis module 200 is activated to combine the background image BGD_IMAGE with the representative object image REP_OBJECT, the motion marks and time tags resulted from the motion status data MOTION_DATA, and the feature image FEATURE_IMAGE into a synthesized image for use as the index picture.

Afterwards, when the input video stream 21 is stored as multiple video clips or files together with the index pictures 22 in a computer database, users of the database can quickly find and retrieve the user-interested video clips or files by visually browsing the index pictures. In addition, the data items of each associated activity record dataset, such as motion-status data, time/date, image features (human face, car number plate, etc.), can be used as query keywords for the users to find certain specific video clips or files.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for processing an input video stream with the purpose of creating at least one index picture for each segment of predefined interest in the input video stream, which comprises:
performing a content extraction process on the video stream to thereby extract a set of content items of predefined interest from the video stream, where the content items of predefined interest include at least one moving object and associated activity record dataset: and
performing a content synthesis process on the extracted content items to thereby create at least one resultant picture that shows all the content items of predefined interest in a predefined manner in which each moving object of predefined interest is tagged with an activity record dataset used to indicate information about the activity of each moving object.

2. The method of claim 1, wherein each moving object and associated activity record dataset are displayed in a 2D (two-dimensional) representation.

3. The method of claim 1, wherein each moving object and associated activity record dataset are displayed in a 3D (three-dimensional) representation.

4. The method of claim 1, wherein the associated activity record dataset of each moving object includes time/date of the presence of the moving object in the video stream.

5. The method of claim 1, wherein in the case of multiple moving objects, each moving object is displayed in a unique color.

6. The method of claim 1, further comprising:
performing a user-interested-event defining process for defining an ROI (region of interest) and event attribute of particular interest.

7. The method of claim 1, wherein the content items of predefined interest include a feature image for each moving object.

8. The method of claim 7, wherein in the case of the moving object is a human being, the feature image is the face of that human being, while in the case of the moving object is an automobile, the feature image is a number plate on that automobile.

9. The method of claim 1, wherein the content items of predefined interest include a representative object image for each moving object.

10. The method of claim 1, further comprising:
performing a hyperlink embedding process for embedding a set of hyperlinks to specified portions of the index picture for linking to associated information items.

11. A system for processing a video stream with the purpose of creating at least one index picture for each segment of predefined interest in the video stream, which comprises a content extraction module for performing a content extraction process on the video stream to thereby extract a set of content items of predefined interest from the video stream, where the content items of predefined interest include at least one moving object and associated activity record dataset; and
a content synthesis module for performing a content synthesis process on the extracted content items to thereby create at least one resultant picture that shows all the content items of predefined interest in a predefined manner in which each moving object of predefined interest is tagged with an activity record dataset used to indicate information about the activity of each moving object.

12. The system of claim 11, wherein each moving object and associated activity record dataset are displayed in a 2D (two-dimensional) representation.

13. The system of claim 11, wherein each moving object and associated activity record dataset are displayed in a 3D (three-dimensional) representation.

14. The system of claim 11, wherein the associated activity record dataset of each moving object includes time/date of the presence of the moving object in the video stream.

15. The system of claim 11, wherein in the case of multiple moving objects, each moving object is displayed in a unique color.

16. The system of claim 11, further comprising:
a user-interested-event defining module for performing a user-interested-event defining process for defining an ROI (region of interest) and event attribute of particular interest.

17. The system of claim 11, wherein the content items of predefined interest include a feature image for each moving object.

18. The system of claim 18, wherein in the case of the moving object is a human being, the feature image is the face of that human being, while in the case of the moving object is an automobile, the feature image is a number plate on that automobile.

19. The system of claim 11, wherein the content items of predefined interest include a representative object image for each moving object.

20. The system of claim 11, further comprising:
performing a hyperlink embedding process for embedding a set of hyperlinks to specified portions of the index picture for linking to associated information items.
